(19) United States
(12) Patent Application Publication
(10) Pub. No.: US 2021/0297728 A1
(43) Pub. Date: Sep. 23, 2021

(54) INFORMATION PROCESSING APPARATUS, INFORMATION PROCESSING SYSTEM, INFORMATION PROCESSING METHOD, AND NON-TRANSITORY COMPUTER-READABLE STORAGE MEDIUM

(71) Applicant: HONDA MOTOR CO., LTD., Tokyo (JP)

(72) Inventors: Yuta Takizawa, Tokyo (JP); Koichi Yahagi, Tokyo (JP)

(73) Assignee: HONDA MOTOR CO., LTD., Tokyo (JP)

(21) Appl. No.: 17/199,592

(22) Filed: Mar. 12, 2021

(30) Foreign Application Priority Data
Mar. 17, 2020 (JP) 2020-046807

(51) Int. Cl. H04N 21/432; H04N 21/4415; H04N 21/845; H04N 21/2387

(52) U.S. Cl. CPC H04N 21/4325; H04N 21/2387; H04N 21/8455; H04N 21/4415

(57) ABSTRACT

An information processing apparatus capable of transmitting/receiving moving image information and voice information to/from another apparatus comprises: a communication unit configured to receive, from the other apparatus, the moving image information and the voice information or the voice information and object information obtained by discretely extracting feature portions of an object captured by the other apparatus since a communication load of the network is not less than a threshold; and a generation unit configured to select, from a storage unit, an object image of moving image information, in which the same object is captured, by authentication processing using the object information, and generate reproduced moving image information by displacing the object image in accordance with an operation amount calculated from a positional shift between the object information and each portion of the object image.

### CROSS-REFERENCE TO RELATED APPLICATION(S)

This application claims priority to and the benefit of Japanese Patent Application No. 2020-046807 filed on Mar. 17, 2020, the entire disclosure of which is incorporated herein by reference.

### BACKGROUND OF THE INVENTION

### Field of the Invention

The present invention relates to an information processing apparatus, an information processing system, an information processing method, and a non-transitory computer-readable storage medium.

### Description of the Related Art

Japanese Patent Laid-Open No. 2016-178419 discloses, as a method of improving the network load, a communication system in which a resolution, a frame rate, and a bit rate are changed in accordance with unidirectional or bidirectional communication or the like.

However, in the communication system according to the conventional technique, when the communication load of a network becomes high, communication of moving image information may be delayed compared to voice information.

The present invention provides an information processing technique capable of reducing the delay of communication of moving image information with respect to communication of voice information when communicating the moving image information and the voice information with another apparatus via a network.

### SUMMARY OF THE INVENTION

According to the first aspect of the present invention, there is provided an information processing apparatus capable of transmitting/receiving moving image information and voice information to/from another apparatus via a network, the information processing apparatus comprising:

a communication unit configured to receive, from the other apparatus via the network, the moving image information and the voice information or the voice information and object information obtained by discretely extracting feature portions of an object captured by an image capturing unit of the other apparatus since a communication load of the network is not less than a threshold;

an information processing unit configured to, if the communication unit receives the moving image information and the voice information from the other apparatus, cause a voice output unit to output the voice information and cause a display unit to display the moving image information corresponding to the voice information;

a storage unit configured to store the moving image information; and

a generation unit configured to, if the communication unit receives the object information and the voice information, select, from the storage unit, an object image of moving image information, in which the same object is captured, by authentication processing using the object information, and generate reproduced moving image information by displacing the object image in accordance with an operation amount calculated from a positional shift between the object information and each portion of the object image,

wherein if the generation unit generates the reproduced moving image information, the information processing unit causes the display unit to display the reproduced moving image information as the moving image information corresponding to the voice information.

According to the second aspect of the present invention, there is provided the information processing apparatus further comprising:

a voice input unit configured to input voice information of an object;

an image capturing unit configured to capture moving image information of the object;

an object information acquisition unit configured to acquire object information obtained by partially extracting the object from the moving image information captured by the image capturing unit;

a state information acquisition unit configured to acquire state information indicating a state of the communication load of the network based on communication with the other apparatus; and

a transmission control unit configured to perform transmission control of transmitting the voice information and one of the moving image information and the object information to the other apparatus via the network based on determination of whether the state information is not less than a threshold.

According to the third aspect of the present invention, there is provided the information processing apparatus, wherein

if the state information is not less than the threshold, the transmission control unit transmits the object information and the voice information to the other apparatus, and

if the state information is less than the threshold, the transmission control unit transmits the moving image information and the voice information to the other apparatus.

According to the fourth aspect of the present invention, there is provided the information processing apparatus, further comprising a moving image update unit configured to update the moving image information stored in the storage unit, based on a timing based on an input from an operation unit or a result of comparing captured objects between frames of the object information.

According to the fifth aspect of the present invention, there is provided the information processing apparatus, wherein

if the captured objects are compared between the frames of the object information received from the other apparatus and it is determined that a new object is captured, the moving image update unit requests the other apparatus as a transmission source of the object information to transmit only the moving image information, and updates the moving image information stored in the storage unit, based on the moving image information transmitted from the other apparatus in response to the transmission request.

According to the sixth aspect of the present invention, there is provided the information processing apparatus, wherein if an operation of the voice input unit is turned off based on the input from the operation unit, the moving image update unit requests the other apparatus as a transmission source of the object information to transmit only the moving image information, and updates the moving image information stored in the storage unit, based on the moving image information transmitted from the other apparatus in response to the transmission request.

According to the seventh aspect of the present invention, there is provided the information processing apparatus, further comprising a moving image correction unit configured to correct the moving image information captured by the image capturing unit and the reproduced moving image information generated by the generation unit,

wherein the moving image correction unit corrects the moving image information and the reproduced moving image information so that a line of sight of the object in the moving image information and the reproduced moving image information matches the image capturing unit.

According to the eighth aspect of the present invention, there is provided the information processing apparatus, wherein the generation unit selects, as an object image of moving image information in which the same object is captured, an object image of moving image information whose similarity of the object is highest by comparison between the object information and the moving image information stored in the storage unit, based on the authentication processing, and generates the reproduced moving image information using the object image of the moving image information.

According to the ninth aspect of the present invention, there is provided an information processing system comprising an information processing apparatus capable of transmitting/receiving moving image information and voice information to/from another apparatus via a network, wherein the information processing apparatus includes

a communication unit configured to receive, from the other apparatus via the network, the moving image information and the voice information or the voice information and object information obtained by discretely extracting feature portions of an object captured by an image capturing unit of the other apparatus since a communication load of the network is not less than a threshold,

an information processing unit configured to, if the communication unit receives the moving image information and the voice information from the other apparatus, cause a voice output unit to output the voice information and cause a display unit to display the moving image information corresponding to the voice information,

a storage unit configured to store the moving image information, and

a generation unit configured to, if the communication unit receives the object information and the voice information, select, from the storage unit, an object image of moving image information, in which the same object is captured, by authentication processing using the object information, and generate reproduced moving image information by displacing the object image in accordance with an operation amount calculated from a positional shift between the object information and each portion of the object image,

wherein if the generation unit generates the reproduced moving image information, the information processing unit causes the display unit to display the reproduced moving image information as the moving image information corresponding to the voice information.

According to the 10th aspect of the present invention, there is provided an information processing method for an information processing apparatus capable of transmitting/receiving moving image information and voice information to/from another apparatus via a network, comprising:

a communication step of receiving, from the other apparatus via the network, the moving image information and the voice information or the voice information and object information obtained by discretely extracting feature portions of an object captured by an image capturing unit of the other apparatus since a communication load of the network is not less than a threshold;

an information processing step of, if the moving image information and the voice information are received from the other apparatus in the communication step, causing a voice output unit to output the voice information and causing a display unit to display the moving image information corresponding to the voice information;

a storage step of storing the moving image information in a storage unit;

a generation step of, if the object information and the voice information are received in the communication step, selecting, from the storage unit, an object image of moving image information, in which the same object is captured, by authentication processing using the object information, and generating reproduced moving image information by displacing the object image in accordance with an operation amount calculated from a positional shift between the object information and each portion of the object image; and

a step of, if the reproduced moving image information is generated in the generation step, causing the display unit to display the reproduced moving image information as the moving image information corresponding to the voice information.

According to the 11th aspect of the present invention, there is provided a non-transitory computer-readable storage medium storing a program for causing a computer to execute each step of an information processing method for an information processing apparatus capable of transmitting/receiving moving image information and voice information to/from another apparatus via a network, wherein the method comprises

a communication step of receiving, from the other apparatus via the network, the moving image information and the voice information or the voice information and object information obtained by discretely extracting feature portions of an object captured by an image capturing unit of the other apparatus since a communication load of the network is not less than a threshold,

an information processing step of, if the moving image information and the voice information are received from the other apparatus in the communication step, causing a voice output unit to output the voice information and causing a display unit to display the moving image information corresponding to the voice information,

a storage step of storing the moving image information in a storage unit,

a generation step of, if the object information and the voice information are received in the communication step, selecting, from the storage unit, an object image of moving image information, in which the same object is captured, by authentication processing using the object information, and generating reproduced moving image information by displacing the object image in accordance with an operation amount calculated from a positional shift between the object information and each portion of the object image, and

a step of, if the reproduced moving image information is generated in the generation step, causing the display unit to display the reproduced moving image information as the moving image information corresponding to the voice information.

According to the information processing apparatus of the first aspect of the present invention, it is possible to reduce the delay of communication of the moving image information with respect to communication of the voice information when communicating the moving image information and the voice information with the other apparatus via the network.

According to the information processing apparatus of the second and third aspects of the present invention, it is possible to perform transmission control of transmitting the voice information and the moving image information or the object information to the other apparatus via the network based on determination of whether the state information indicating the state of the communication load of the network is equal to or more than the threshold.

According to the information processing apparatus of the fourth aspect of the present invention, it is possible to update the moving image information stored in the storage unit based on a timing based on an input from the operation unit or a result of comparing captured objects between frames of the object information.

According to the information processing apparatus of the fifth aspect of the present invention, if the captured objects are compared between the frames of the object information and it is determined that a new object is captured, it is possible to update the moving image information stored in the storage unit based on the moving image information in which the new object is captured.

According to the information processing apparatus of the sixth aspect of the present invention, it is possible to update the moving image information stored in the storage unit at a timing of turning off the operation of the voice input unit, which is not influenced by the delay of communication of the moving image information.

According to the information processing apparatus of the seventh aspect of the present invention, it is possible to correct the moving image information and the reproduced moving image information so that the line of sight of the object matches the image capturing unit. Thus, when a video conference is performed by transmitting/receiving the moving image information and the voice information to/from the other apparatus via the network, it is possible to perform bidirectional communication in which the direction of the line of sight in the object image is set to a more natural direction.

According to the information processing apparatus of the eighth aspect of the present invention, by selecting, as the object image of the moving image information in which the same object is captured, the object image of the moving image information whose similarity of the object is highest by comparison between the object information and the moving image information stored in the storage unit based on the authentication processing, it is possible to generate more accurate reproduced moving image information.

According to the information processing system of the ninth aspect of the present invention, the information processing method of the 10th aspect of the present invention, and the non-transitory computer-readable storage medium of the 11th aspect of the present invention, it is possible to reduce the delay of communication of the moving image information with respect to communication of the voice information when communicating the moving image information and the voice information with the other apparatus via the network.

### BRIEF DESCRIPTION OF THE DRAWINGS

FIG. 1 is a view showing an example of the configuration of an information processing system according to an embodiment;

FIG. 2 is a block diagram showing an example of the hardware arrangement of an information processing apparatus;

FIG. 3 is a block diagram showing an example of the functional arrangement of the information processing apparatus;

FIG. 4 is a view for exemplarily explaining object information;

FIG. 5 is a flowchart for explaining the procedure of information reception processing in the information processing apparatus;

FIG. 6 is a flowchart for explaining the procedure of information transmission processing in the information processing apparatus; and

FIG. 7 is a view for exemplarily explaining transmission of moving image information or that of object information which is controlled based on a communication load.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

(System Configuration)

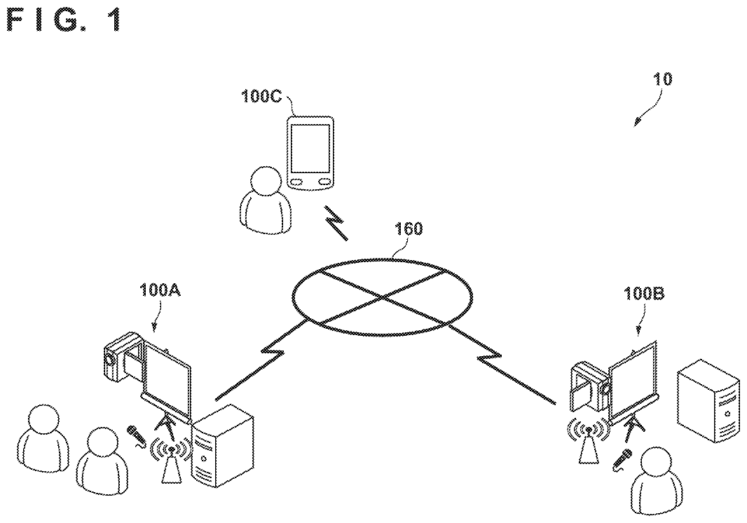

FIG. 1 is a view showing an example of the configuration of an information processing system 10 according to an embodiment. Referring to FIG. 1, the information processing system 10 includes a plurality of information processing apparatuses 100A, 100B, and 100C connected to a network 160 by wireless or wired communication. The information processing apparatuses 100A, 100B, and 100C can transmit/receive moving image information and voice information to/from another apparatus via the network 160. For example, the information processing apparatus 100A can transmit/receive moving image information and voice information to/from another apparatus (information processing apparatus 100B or 100C) via the network 160. The configuration of the information processing system 10 allows, for example, a video conference or communication such as conversation with a user at a remote site via the network 160.

In the example shown in FIG. 1, the information processing apparatuses 100A and 100B are configured as desktop apparatuses, and the information processing apparatus 100C is configured as a potable terminal apparatus. However, the information processing apparatus according to this embodiment may have any apparatus arrangement. The number of information processing apparatuses connected to the network 160 shown in FIG. 1 is exemplified, and it is possible to further connect a plurality of information processing apparatuses to the network 160, and bidirectionally transmit/receive moving image information and voice information.

The plurality of information processing apparatuses 100A, 100B, and 100C have the same arrangement, and the information processing apparatus 100A will be described as a representative below. Assume that the information processing apparatus 100B or 100C serves as another apparatus when seen from the information processing apparatus 100A.

(Hardware Arrangement of Information Processing Apparatus 100A)

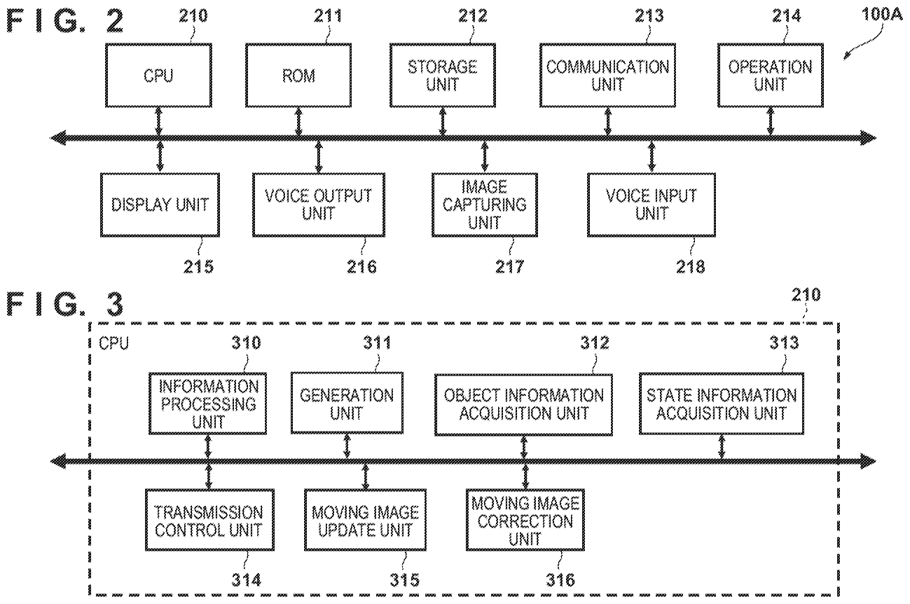

FIG. 2 is a block diagram showing an example of the hardware arrangement of the information processing apparatus 100A. The information processing apparatus 100A includes a CPU (Central Processing Unit) 210 for controlling the overall apparatus, a ROM (Read Only Memory) 211 storing a program to be executed by the CPU 210, and a storage unit 212 for storing various kinds of information as a work area used when the CPU 210 executes the program. The storage unit 212 can be formed by, for example, a RAM (Random Access Memory), a memory card, a flash memory, an HDD (Hard Disk Drive), or the like. The information processing apparatus 100A can save, in the storage unit 212, information acquired by communication with another apparatus via the network 160.

The information processing apparatus 100A also includes a communication unit 213 functioning as an interface for connection to the network 160, and an operation unit 214 for operating the information processing apparatus 100A. Furthermore, the information processing apparatus 100A includes a display unit 215 for displaying moving image information, a voice output unit 216 for outputting voice information, an image capturing unit 217 for inputting the moving image information, and a voice input unit 218 for inputting the voice information.

The display unit 215 can display the moving image information received from the other apparatus via the network 160, and for example, a display device using liquid crystal or organic EL (Electro-Luminescence), a projector, or the like is used.

The voice output unit 216 can reproduce, by a reproduction device of the voice information such as a loudspeaker, the voice information received from the other apparatus via the network 160. The CPU 210 can perform reproduction control by synchronizing the moving image information and the voice information with each other.

The image capturing unit 217 is a camera capable of capturing a moving image. For example, a digital camera including an image sensor such as a CMOS (Complementary Metal-Oxide Semiconductor) sensor or CCD (Charge Coupled Device) sensor is used.

The voice input unit 218 is a sound collecting device such as a microphone, and acquires voice information of the user together with capturing of an image of an object by the image capturing unit 217. The type and the like of the voice input unit 218 are not limited and, for example, a microphone or the like capable of setting the directivity in accordance with the number of objects or the peripheral environment of an object is used.

(Functional Arrangement of Information Processing Apparatus 100A)

FIG. 3 is a block diagram showing an example of the functional arrangement of the information processing apparatus 100A. The information processing apparatus 100A includes, as the functional arrangement, an information processing unit 310, a generation unit 311, an object information acquisition unit 312, a state information acquisition unit 313, a transmission control unit 314, a moving image update unit 315, and a moving image correction unit 316. The functional arrangement is implemented when the CPU 210 of the information processing apparatus 100A executes a predetermined program loaded from the ROM 211. The arrangement of each unit of the functional arrangement of the information processing apparatus 100A may be formed by an integrated circuit or the like as long as the same function is implemented.

The communication unit 213 of the information processing apparatus 100A receives, from another apparatus (for example, the information processing apparatus 100B or 100C) via the network 160, moving image information and voice information or the voice information and object information obtained by discretely extracting feature portions of an object captured by the image capturing unit of the other apparatus since the communication load of the network 160 is equal to or more than a threshold, that is, high.

The information processing unit 310 processes the information received from the other apparatus (information processing apparatus 100B or 100C) via the network 160. If the communication unit 213 receives the moving image information and the voice information from the other apparatus, the information processing unit 310 causes the voice output unit 216 to output the voice information received from the other apparatus, and causes the display unit 215 to display the moving image information corresponding to the voice information.

When the information processing unit 310 performs the display processing of the moving image information, the storage unit 212 stores the moving image information received by the communication unit 213 of the information processing apparatus 100A via the network 160. The stored moving image information is used when the generation unit 311 (to be described later) generates (reproduces) the moving image information (reproduced moving image information) based on the object information.

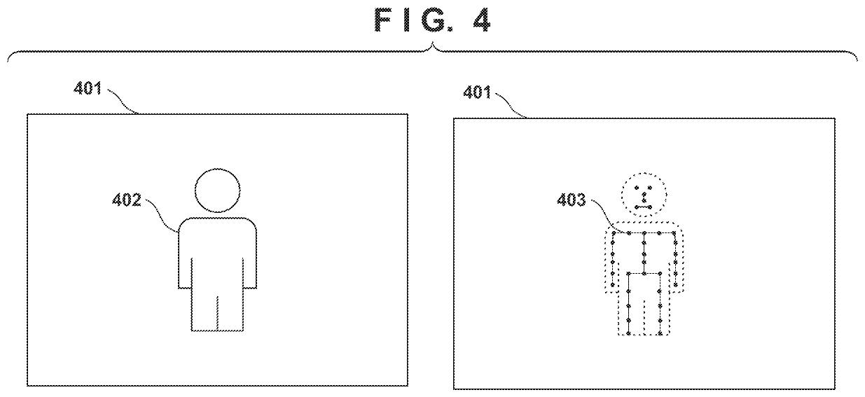

The object information acquisition unit 312 acquires the object information obtained by partially extracting the object from the moving image information captured by the image capturing unit 217. FIG. 4 is a view for exemplarily explaining the object information. As shown in FIG. 4, the object information acquisition unit 312 specifies a captured object 402 (person) for each frame (for example, a frame 401 shown in FIG. 4) of the moving image information. If each frame of the moving image information includes a plurality of captured objects, the object information acquisition unit 312 specifies each object in each frame, and acquires object information for each object.

The object information acquisition unit 312 acquires, as the object information, information (thinning information of a point group) obtained by discretely extracting feature portions of an object specified as a solid model. The feature portions of the object include, for example, the joints (shoulders, elbows, wrists, and knees) of respective portions, the positions and directions of the limb and face, and parts (eyes, nose, mouth, and ears) of the face, and the object information includes position information and angle information of each feature portion and information concerning the depth of focus with respect to the image capturing unit (camera).

The object information can indicate a linear object 403 by connecting the pieces of information (position information) of the feature portions of the object, thereby reducing the information amount, as compared with the object 402 of the solid model in each frame of the moving image information.

The state information acquisition unit 313 acquires state information indicating the state of the communication load of the network 160 based on communication with the other apparatus (for example, the information processing apparatus 100B or 100C). The state information is, for example, information concerning the time required for the information processing apparatus 100A to communicate with the other apparatus, and the state information acquisition unit 313 acquires the state information by periodically communicating a predetermined amount of information with the other apparatus.

The state information acquisition unit 313 periodically communicates with the other apparatus via the communication unit 213, and determines whether a delay occurs with respect to a reference communication time (threshold). If the state information is equal to or more than the communication time (threshold), the state information acquisition unit 313 determines that the communication load of the network is equal to or more than the threshold, that is, high. On the other hand, if the state information is less than the communication time (threshold), the state information acquisition unit 313 determines that the communication load of the network is less than the threshold, that is, low.

FIG. 7 is a view for exemplarily explaining transmission of the moving image information or that of the object information which is controlled based on the communication load, in which the abscissa represents the time and the ordinate represents the communication load. The communication load varies with the lapse of time. If the communication load is equal to or more than the threshold, the transmission region of the object information by the transmission control unit 314 is obtained. In the transmission region of the object information, the transmission control unit 314 transmits the object information and the voice information to the other apparatus. Alternatively, if the communication load is less than the threshold, the transmission region of the moving image information by the transmission control unit 314 is obtained. In the transmission region of the moving image information, the transmission control unit 314 transmits the moving image information and the voice information to the other apparatus.

The transmission control unit 314 performs transmission control of transmitting the moving image information or the object information and the voice information to the other apparatus via the network 160 based on the determination of whether the state information is equal to or more than the threshold. The moving image information is information captured by the image capturing unit 217, and the object information is information (403 of FIG. 4) acquired by the object information acquisition unit 312.

If the state information is equal to or more than the threshold, the transmission control unit 314 transmits the object information and the voice information to the other apparatus; otherwise, the transmission control unit 314 transmits the moving image information and the voice information to the other apparatus. When transmitting the information to the other apparatus, the transmission control unit 314 transmits, in combination with the transmission information, attribute information that makes it possible to discriminate between the moving image information and the object information. On the reception side of the information, the communication unit 213 can discriminate between the moving image information and the object information based on the attribute information.

If the communication unit 213 receives the voice information and the object information obtained by discretely extracting the feature portions of the object captured by the image capturing unit of the other apparatus since the communication load of the network 160 is equal to or more than the threshold, that is, high, the generation unit 311 selects, from the storage unit 212, an object image of the moving image information, in which the same object is captured, by authentication processing using the object information, and generates, as the moving image information of the object, moving image information (reproduced moving image information) by displacing the object image in accordance with an operation amount calculated from a positional shift between the object information and each portion of the selected object image of the moving image information.

If the communication unit 213 receives the object information from the other apparatus, the generation unit 311 selects, based on the feature of the object information, from the storage unit 212, the moving image information in which the corresponding object (person) is captured. By the authentication processing (for example, a face recognition technique) using the object information, the generation unit 311 specifies, as the same object, an object corresponding to the object of the object information from the objects (persons) captured in the moving image information.

Then, if the same object (person) can be specified, the generation unit 311 selects, from the storage unit 212, the moving image information in which the specified same object (person) is captured. The generation unit 311 selects, as the object image of the moving image information in which the same object (person) is captured, the object image of the moving image information whose similarity of the object is highest by comparison between the object information and the moving image information stored in the storage unit based on the authentication processing, and generates moving image information (reproduced moving image information) by displacing the object image in accordance with an operation amount calculated from a positional shift between the object information and each portion of the selected object image. By selecting, as the object image of the moving image information in which the same object is captured, the object image of the moving image information whose similarity of the object is highest by comparison between the object information and the moving image information stored in the storage unit 212 based on the authentication processing, it is possible to generate more accurate reproduced moving image information.

If there exist a plurality of candidates of the moving image information, the generation unit 311 performs similarity comparison with respect to the frames of the object information and the frames of the moving image information, and selects the object image of the moving image information including the frame whose similarity is highest. Even if there exist a plurality of candidates of the moving image information, the generation unit 311 can select the object image of the moving image information closest to a captured scene (for example, a scene in which the person is smiling and talking, is standing and talking, or is sitting and talking) in the frame of the object information by performing similarity comparison on a frame basis.

If the generation unit 311 selects the object image of the moving image information, it associates the feature portions of the object in the object information with those of the object in the object image of the moving image information, and calculates a shift of each feature portion as a feature portion vector representing the operation of the object. The generation unit 311 calculates the operation amount of each feature portion based on the direction and magnitude of the feature portion vector. The generation unit 311 displaces each feature portion of the object in the object image of the moving image information in accordance with the calculated operation amount.

With respect to a portion (peripheral portion) other than each feature portion, the operation amount of the peripheral portion is calculated based on the relative positional relationship between the feature portion and the peripheral portion and the operation amount calculated for the feature portion. The generation unit 311 displaces the peripheral portion of the object in the object image of the moving image information in accordance with the calculated operation amount of the peripheral portion.

The generation unit 311 generates, as the moving image information (reproduced moving image information) based on the object information, the object image in which each feature portion and its peripheral portion of the object in the object image of the moving image information selected from the storage unit 212 are respectively displaced in accordance with the calculated operation amounts.

If the generation unit 311 generates the moving image information (reproduced moving image information), the information processing unit 310 causes the display unit 215 to display the reproduced moving image information as the moving image information corresponding to the voice information.

The moving image update unit 315 updates the moving image information stored in the storage unit 212 based on a timing based on an input from the operation unit 214 or a result of comparing the captured objects between the frames of the object information. As a timing of updating the moving image information, the moving image update unit 315 compares the captured objects between the frames of the object information received from the other apparatus, and requests, if it is determined that a new object is captured, the other apparatus as the transmission source of the object information to transmit only the moving image information. Then, based on the moving image information transmitted from the other apparatus in response to the transmission request, the moving image update unit 315 updates the moving image information stored in the storage unit 212.

If, for example, while an object A is captured in a frame F1 of the object information, the object A and a new object B are captured in a next frame F2 of the object information, the moving image update unit 315 requests the other apparatus as the transmission source of the object information to transmit only the moving image information in order to store information of the object B in the storage unit 212, and updates the moving image information stored in the storage unit based on the moving image information (moving image information in which the object A and the new object B are captured) transmitted from the other apparatus in response to the transmission request. If the captured objects are compared between the frames of the object information and it is determined that the new object is captured, the moving image update unit 315 can update the moving image information stored in the storage unit 212 based on the moving image information in which the new object is captured.

As a timing of updating the moving image information, if the operation of the voice input unit 218 is turned off based on the input from the operation unit 214, the moving image update unit 315 notifies the other apparatus of the OFF state of the voice input unit 218, and requests the other apparatus as the transmission source of the object information to transmit only the moving image information. Then, the moving image update unit 315 updates the moving image information stored in the storage unit 212 based on the moving image information transmitted from the other apparatus in response to the transmission request. This makes it possible to update the moving image information stored in the storage unit 212 at a timing of turning off the operation of the voice input unit, which is not influenced by the delay of communication of the moving image information.

The moving image correction unit 316 corrects the moving image information captured by the image capturing unit of the other apparatus and the moving image information (reproduced moving image information) generated by the generation unit 311. The moving image correction unit 316 corrects the moving image information and the reproduced moving image information so that the line of sight of the object in the moving image information and the reproduced moving image information matches the image capturing unit. Thus, when a video conference is performed by transmitting/receiving the moving image information and the voice information to/from the other apparatus via the network, it is possible to perform bidirectional communication in which the direction of the line of sight in the object image is set to a more natural direction.

(Example of Information Reception Processing)

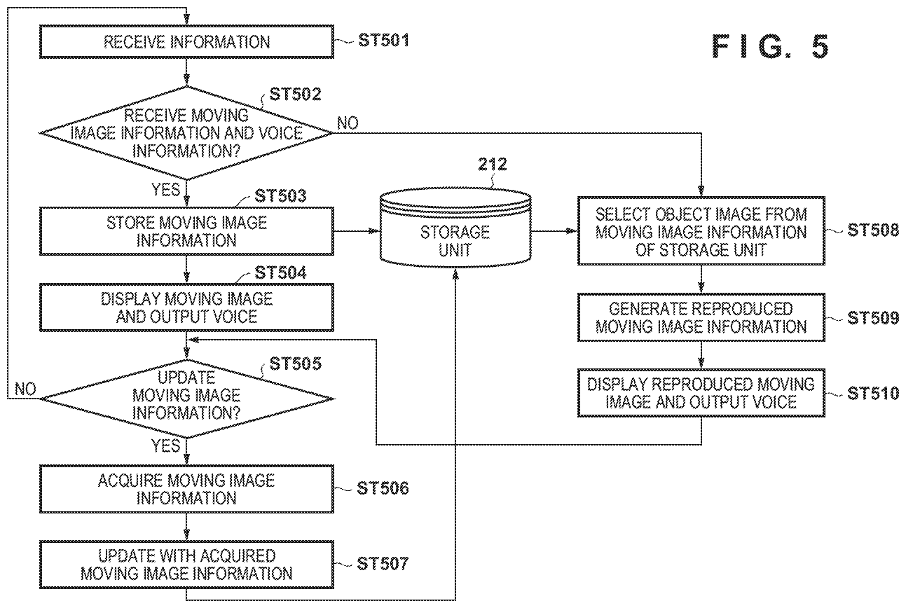

The procedure of information processing in the information processing apparatus 100A will be described next. FIG. 5 is a flowchart for explaining the procedure of information reception processing in the information processing apparatus 100A.

In step ST501, the communication unit 213 receives, from another apparatus via the network 160, moving image information and voice information or the voice information and object information obtained by discretely extracting feature portions of an object captured by the image capturing unit of the other apparatus since the communication load of the network 160 is equal to or more than the threshold, that is, high. The information received by the communication unit 213 is combined with attribute information that makes it possible to discriminate between the moving image information and the object information, and it is thus possible to determine, based on the attribute information, the type (moving image information or object information) of information received together with the voice information.

In step ST502, if the communication unit 213 receives the moving image information and the voice information (YES in step ST502), the storage unit 212 stores, in step ST503, the moving image information received by the communication unit 213 via the network 160.

In step ST504, the information processing unit 310 causes the voice output unit 216 to output the voice information received from the other apparatus via the network 160, and causes the display unit 215 to display the moving image information corresponding to the voice information.

In step ST505, the moving image update unit 315 determines whether to update the moving image information stored in the storage unit 212. As a timing of updating the moving image information, the moving image update unit 315 can update the moving image information stored in the storage unit 212 based on a timing based on an input from the operation unit 214 or a result of comparing captured objects between frames of the object information.

If the moving image information is updated (YES in step ST505), the moving image update unit 315 requests, in step ST506, the other apparatus as the transmission source of the object information to transmit only the moving image information. In step ST507, the moving image update unit 315 updates the moving image information stored in the storage unit 212, based on the moving image information transmitted from the other apparatus in response to the transmission request.

On the other hand, if it is determined in step ST505 not to update the moving image information (NO in step ST505), the information processing apparatus 100A returns the process to step ST501 and repeatedly executes the same processing.

If it is determined in step ST502 that the communication unit 213 receives the object information and the voice information (NO in step ST502), the generation unit 311 selects, in step ST508, from the storage unit 212, an object image of the moving image information, in which the same object is captured, by authentication processing using the object information. In step ST509, the generation unit 311 generates, as moving image information of the object, moving image information (reproduced moving image information) by displacing the object image in accordance with an operation amount calculated from a positional shift between the object information and each portion of the object image of the moving image information selected in step ST508.

Then, in step ST510, if the generation unit 311 generates the moving image information (reproduced moving image information), the information processing unit 310 causes the display unit 215 to display the reproduced moving image information as the moving image information corresponding to the voice information. The information processing unit 310 performs reproduction control by synchronizing the moving image information (reproduced moving image information) and the voice information with each other.

(Example of Information Transmission Processing)

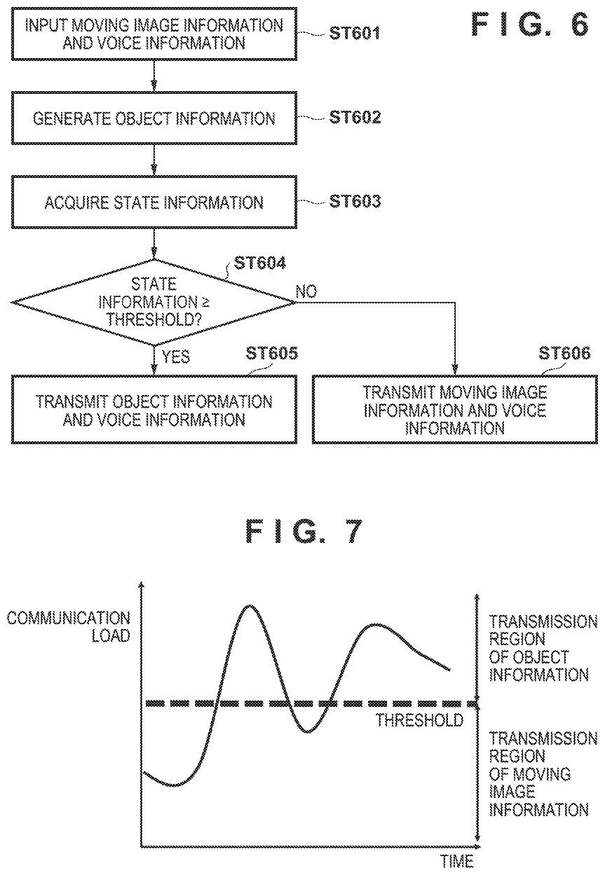

FIG. 6 is a flowchart for explaining the procedure of information transmission processing in the information processing apparatus 100A. In step ST601, the image capturing unit 217 inputs moving image information of an object (person) by capturing a moving image, and the voice input unit 218 acquires voice information of the object (person) together with capturing of an image of the object (person) by the image capturing unit 217.

In step ST602, the object information acquisition unit 312 acquires object information by partially extracting the object from the moving image information captured by the image capturing unit 217.

In step ST603, the state information acquisition unit 313 acquires state information indicating the state of the communication load of the network 160 based on communication with another apparatus.

In step ST604, the state information acquisition unit 313 periodically communicates with the other apparatus via the communication unit 213, and determines whether a delay occurs with respect to the reference communication time (threshold).

If it is determined in step ST604 that the state information is equal to or more than the communication time (threshold) (YES in step ST604), the state information acquisition unit 313 determines that the communication load of the network is equal to or more than the threshold, that is, high. If the state information is equal to or more than the threshold, the transmission control unit 314 transmits, in step ST605, the object information and the voice information to the other apparatus. When transmitting the object information and the voice information to the other apparatus, the transmission control unit 314 transmits, in combination with the transmission information, attribute information that makes it possible to discriminate between the moving image information and the object information. By transmitting the attribute information in combination with the transmission information (object information and voice information), the reception side of the information can discriminate between the moving image information and the object information based on the attribute information.

On the other hand, if it is determined in step ST604 that the state information is less than the communication time (threshold), the state information acquisition unit 313 determines that the communication load of the network is less than the threshold, that is, low. Then, if the state information is equal to or more than the threshold, the transmission control unit 314 transmits the object information and the voice information to the other apparatus; otherwise, the transmission control unit 314 transmits, in step ST606, the moving image information and the voice information to the other apparatus. When transmitting the moving image information and the voice information to the other apparatus, the transmission control unit 314 transmits, in combination with the transmission information, the attribute information that makes it possible to discriminate between the moving image information and the object information. By transmitting the attribute information in combination with the transmission information (moving image information and voice information), the reception side of the information can discriminate between the moving image information and the object information based on the attribute information.

### Other Embodiments

The present invention can also be implemented by processing of supplying a program for implementing one or more functions of the above-described embodiment to a system or apparatus via a network or a storage medium, and causing one or more processors of the computer of the system or the apparatus to read out and execute the supplied program. Furthermore, the present invention can be implemented by a circuit for implementing one or more functions.

The invention is not limited to the foregoing embodiments, and various variations/changes are possible within the spirit of the invention.

What is claimed is:

1. An information processing apparatus capable of transmitting/receiving moving image information and voice information to/from another apparatus via a network, the information processing apparatus comprising:
a communication unit configured to receive, from the other apparatus via the network, the moving image information and the voice information or the voice information and object information obtained by discretely extracting feature portions of an object captured by an image capturing unit of the other apparatus since a communication load of the network is not less than a threshold;
an information processing unit configured to, if the communication unit receives the moving image information and the voice information from the other apparatus, cause a voice output unit to output the voice information and cause a display unit to display the moving image information corresponding to the voice information;
a storage unit configured to store the moving image information; and
a generation unit configured to, if the communication unit receives the object information and the voice information, select, from the storage unit, an object image of moving image information, in which the same object is captured, by authentication processing using the object information, and generate reproduced moving image information by displacing the object image in accordance with an operation amount calculated from a positional shift between the object information and each portion of the object image,
wherein if the generation unit generates the reproduced moving image information, the information processing unit causes the display unit to display the reproduced moving image information as the moving image information corresponding to the voice information.

2. The apparatus according to claim 1, further comprising:
a voice input unit configured to input voice information of an object;
an image capturing unit configured to capture moving image information of the object;
an object information acquisition unit configured to acquire object information obtained by partially extracting the object from the moving image information captured by the image capturing unit;
a state information acquisition unit configured to acquire state information indicating a state of the communication load of the network based on communication with the other apparatus; and
a transmission control unit configured to perform transmission control of transmitting the voice information and one of the moving image information and the object information to the other apparatus via the network based on determination of whether the state information is not less than a threshold.

3. The apparatus according to claim 2, wherein
if the state information is not less than the threshold, the transmission control unit transmits the object information and the voice information to the other apparatus, and
if the state information is less than the threshold, the transmission control unit transmits the moving image information and the voice information to the other apparatus.

4. The apparatus according to claim 2, further comprising a moving image update unit configured to update the moving image information stored in the storage unit, based on a timing based on an input from an operation unit or a result of comparing captured objects between frames of the object information.

5. The apparatus according to claim 4, wherein
if the captured objects are compared between the frames of the object information received from the other apparatus and it is determined that a new object is captured, the moving image update unit requests the other apparatus as a transmission source of the object information to transmit only the moving image information, and updates the moving image information stored in the storage unit, based on the moving image information transmitted from the other apparatus in response to the transmission request.

6. The apparatus according to claim 4, wherein if an operation of the voice input unit is turned off based on the input from the operation unit, the moving image update unit requests the other apparatus as a transmission source of the object information to transmit only the moving image information, and updates the moving image information stored in the storage unit, based on the moving image information transmitted from the other apparatus in response to the transmission request.

7. The apparatus according to claim 2, further comprising a moving image correction unit configured to correct the moving image information captured by the image capturing unit and the reproduced moving image information generated by the generation unit,
wherein the moving image correction unit corrects the moving image information and the reproduced moving image information so that a line of sight of the object in the moving image information and the reproduced moving image information matches the image capturing unit.

8. The apparatus according to claim 1, wherein the generation unit selects, as an object image of moving image information in which the same object is captured, an object image of moving image information whose similarity of the object is highest by comparison between the object information and the moving image information stored in the storage unit, based on the authentication processing, and generates the reproduced moving image information using the object image of the moving image information.

9. An information processing system comprising an information processing apparatus capable of transmitting/receiving moving image information and voice information to/from another apparatus via a network, wherein the information processing apparatus includes
a communication unit configured to receive, from the other apparatus via the network, the moving image information and the voice information or the voice information and object information obtained by discretely extracting feature portions of an object captured by an image capturing unit of the other apparatus since a communication load of the network is not less than a threshold,
an information processing unit configured to, if the communication unit receives the moving image information and the voice information from the other apparatus, cause a voice output unit to output the voice information and cause a display unit to display the moving image information corresponding to the voice information,
a storage unit configured to store the moving image information, and
a generation unit configured to, if the communication unit receives the object information and the voice information, select, from the storage unit, an object image of moving image information, in which the same object is captured, by authentication processing using the object information, and generate reproduced moving image information by displacing the object image in accordance with an operation amount calculated from a positional shift between the object information and each portion of the object image,
wherein if the generation unit generates the reproduced moving image information, the information processing unit causes the display unit to display the reproduced moving image information as the moving image information corresponding to the voice information.

10. An information processing method for an information processing apparatus capable of transmitting/receiving moving image information and voice information to/from another apparatus via a network, comprising:
a communication step of receiving, from the other apparatus via the network, the moving image information and the voice information or the voice information and object information obtained by discretely extracting feature portions of an object captured by an image capturing unit of the other apparatus since a communication load of the network is not less than a threshold;
an information processing step of, if the moving image information and the voice information are received from the other apparatus in the communication step, causing a voice output unit to output the voice information and causing a display unit to display the moving image information corresponding to the voice information;
a storage step of storing the moving image information in a storage unit;
a generation step of, if the object information and the voice information are received in the communication step, selecting, from the storage unit, an object image of moving image information, in which the same object is captured, by authentication processing using the object information, and generating reproduced moving image information by displacing the object image in accordance with an operation amount calculated from a positional shift between the object information and each portion of the object image; and
a step of, if the reproduced moving image information is generated in the generation step, causing the display unit to display the reproduced moving image information as the moving image information corresponding to the voice information.

11. A non-transitory computer-readable storage medium storing a program for causing a computer to execute each step of an information processing method for an information processing apparatus capable of transmitting/receiving moving image information and voice information to/from another apparatus via a network, wherein the method comprises
a communication step of receiving, from the other apparatus via the network, the moving image information and the voice information or the voice information and object information obtained by discretely extracting feature portions of an object captured by an image capturing unit of the other apparatus since a communication load of the network is not less than a threshold,
an information processing step of, if the moving image information and the voice information are received from the other apparatus in the communication step, causing a voice output unit to output the voice information and causing a display unit to display the moving image information corresponding to the voice information,
a storage step of storing the moving image information in a storage unit,
a generation step of, if the object information and the voice information are received in the communication step, selecting, from the storage unit, an object image of moving image information, in which the same object is captured, by authentication processing using the object information, and generating reproduced moving image information by displacing the object image in accordance with an operation amount calculated from a positional shift between the object information and each portion of the object image, and
a step of, if the reproduced moving image information is generated in the generation step, causing the display unit to display the reproduced moving image information as the moving image information corresponding to the voice information.
